(19) United States
(12) Patent Application Publication
(10) Pub. No.: US 2007/0077918 A1
(43) Pub. Date: Apr. 5, 2007

(54) System and method for providing customized ring back tones using a gateway switching node

(75) Inventors: John C. V. Nguyen, Naperville, IL (US); David S. Benco, Winfield, IL (US); Paresh C. Kanabar, Naperville, IL (US); Huixian Song, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/240,864

(22) Filed: Sep. 30, 2005

(51) Int. Cl. H04Q 7/38

(52) U.S. Cl. 455/414.1

(57) ABSTRACT

A system and method for providing Custom Ring Back Tones (CRBTs) to calling party terminals calling called party wireless terminals in a wireless communications network is provided. A Gateway Switching Node connected provides a centralized interface between the PSTN and the switching nodes serving the called party terminals. The Gateway Switching Node connects a CRBT Server with the calling party terminals to provide the CRBTs thereto.

### BACKGROUND OF THE INVENTION

This invention relates to a system and method for alerting calling parties that their calls are ringing called parties, and more particularly to a system and method for providing Custom Ring Back Tones via a Gateway Switching Node.

While the invention is particularly directed to the art of wireless telecommunications, and will be thus described with specific reference thereto, it will be appreciated that the invention may have usefulness in other fields and applications including wireline telecommunication systems.

A ring back tone is a ringing sound that a calling party hears on the calling party terminal when calling a called party terminal. Traditional ring back tones are simple, audible signals such as tones, beeps, etc., sent by the telecommunications network to the calling party terminal to let the calling party know that the call they are attempting to make to a called party has been put through and has reached the called party terminal. The ring back tone the calling party hears on the calling party terminal simulates the ringing alert sent to, and produce by, the called party terminal that is used to alert the called party that the called party terminal is being called.

Telecommunications Service Providers have begun providing a Custom-Ring Back Tone (CRBT) which enables the called party to replace the traditional ring back tone with a ring back tone of their choosing such as a snippet of a song, a bit of film dialog, a recorded voice message, or other sound effects. Typically, telecommunication systems customers wanting CRBTs subscribe to this service and the telecommunication system Service Providers send the CRBTs to the terminals of the calling parties who call them. The subscribers, also known as the called parties, can have different selected CRBTs provided to different groups of one or more calling party terminals, if so desired.

The CRBT is provided to the calling party terminal on the voice path of the call leg and therefore, any calling party terminal can receive a CRBT, regardless of the make or model or whether the call is placed from a mobile or landline number. CRBTs are stored on one or more servers in the Service Provider's telecommunications network. When custom ring back service subscribers receive a call, the Service Provider's content management application checks to see if the subscriber has assigned that caller a CRBT, and if so, the sends a command to the server, activating the selected audio clip instead of a standard ring.

Conventional implementations providing CRBTs use either the originating switching node, that is the switching node servicing the calling party, or the serving switching node, that is the switching node servicing the called party, to provide the CRBT to the calling party terminal from the CRBT Server. These conventional implementations require extensive provisioning at many switching nodes since there are many originating and serving switching nodes in a Service Provider's telecommunications network. Furthermore, there are typically only a small number of CRBT Servers in any given telecommunications network, and with the switching nodes spread out over many locations, even nationwide, the large numbers of connections often must span many miles imposing severe signaling demands on the network. These connections are often made via the Public Switched Telephone Network (PSTN) or inter-exchange carrier networks further complicating the signaling demands.

It is desirable to provide a new and improved system and method of providing CRBTs which solves these problems.

### SUMMARY OF THE INVENTION

A system for providing CRBTs to calling party terminals calling called party wireless terminals in a wireless communications network is provided. The system includes a CRBT Server for providing CRBTs, and a Gateway Switching Node connected to the PSTN and a plurality of wireless communications network switching nodes for providing a centralized interface therebetween. The Gateway Switching Node routes incoming calls from the PSTN to the wireless communications network switching nodes for connection to the called party wireless terminals and connects the CRBT Server with the calling party terminals for providing the CRBTs thereto.

A method for providing CRBTs to calling party terminals is also provided. The method includes routing calls from calling party terminals from the PSTN to a Gateway Switching Node, routing the calls from the Gateway Switching Node to the different switching nodes serving called party wireless terminals in a wireless network, determining that the calling party terminals are to receive CRBTs, determining the CRBTs to be provided, creating voice paths through the Gateway Switching Node between a CRBT Server and the calling party terminals, sending the CRBTs from the CRBT Server to the calling party terminals via the voice paths, and creating voice paths between the calling party terminals and the corresponding called party terminals for voice communication therebetween.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a telecommunications system as well as a system for providing CRBTs to calling party terminals;

FIG. 2 in a flow chart illustrating a method for providing CRBTs; and

FIG. 3 is a message flow diagram illustrating one example of at least some of the messaging used when providing CRBTs.

### DETAILED DESCRIPTION OF THE PREFERRED EMBODIMENTS

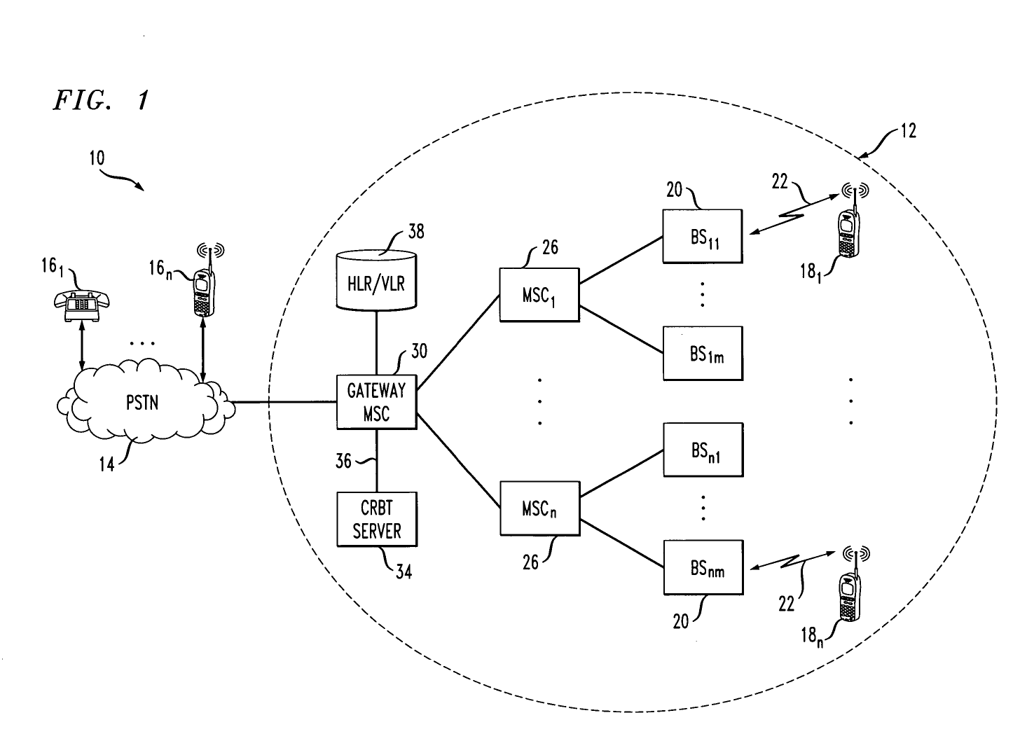

Referring now to the drawings wherein the showings are for purposes of illustrating the preferred embodiments of the invention only and not for purposes of limiting same, FIG. 1 provides a view of the preferred system according to the present invention. As shown, FIG. 1 illustrates portions of a telecommunications system shown generally at 10. The telecommunications system 10 includes a wireless telecommunications network 12, also referred to as a wireless network. The wireless network 12 can be a CDM, GSM or other type of wireless network. The wireless network 12 is connected to the Public Switched Telephone Network (PSTN) 14 for providing telecommunications services therebetween. In this manner, a plurality of calling parties, using calling party terminals 16₁-16ₙ can communicate with a plurality of called parties by calling the corresponding called party terminals 18₁-18ₙ. The calling party terminals 16, which can also be referred to as phones, are connected the PSTN and can be wireline terminals, or wireless terminals connected to the PSTN via a wireless telecommunications network. The called party terminals 18 are wireless terminals, also referred to as wireless phones or cellular phones, communicating with the calling party terminals via the wireless network 12 and the PSTN 14.

The wireless network 12 includes a plurality of Base Stations 20 for providing over-the-air communications via wireless connections 22 to wireless terminals in their proximity, such as the called party terminals 18. The wireless network 12 also includes a plurality of switching nodes, which can include wireless switching nodes or Mobile Switching Centers (MSCs) 26, connected to the Base Stations 20 for setting up calls and routing calls to/from the wireless terminals 18. Typically an MSC 26, such as MSC₁, is connected to one or more Base Stations 20, such as BS₁₁ through BS₁ₙ, so as to provide wireless communications to the wireless terminals 18 in one or more geographic areas, also known as cells. The wireless network 12 includes a plurality of MSCs 26, (shown as MSC₁-MSCₙ), each connected to a corresponding group of one or more Base Stations 20 (shown as BS₁₁-BS₁ₙ through BSₙ₁-BSₙₘ).

A Gateway MSC 30 is connected to the PSTN 14 for receiving incoming calls from the PSTN made to the wireless terminals 18 in the wireless network 12. The Gateway MSC 30 is also connected to the MSCs 26 for routing calls, and call messaging, to/from the appropriate MSCs to enable calling party terminals 16 to communicate with called party terminals 18. In this manner, the Gateway MSC 30 provides a centralized interface between the MSCs 26 of the wireless network 12 and the PSTN 14 for receiving incoming calls from the PSTN made to called party wireless terminals 18 served by the MSCs as described in further detail below.

A CRBT Server 34 is connected to the Gateway MSC 30 via a known connection an example, which should not be considered limiting, can include an ISUP trunk. The use of a centralized Gateway MSC 30 enables CRBT Server 34 to be more closely coupled with the Gateway MSC than conventional CRBT switching node schemes. In conventional CRBT systems, many MSCs must be connected to the CRBT Server, and many of the these connections must span vast distances and use PSTN or inter-exchange carrier networks. The use of a Gateway MSC 30 enables the CRBT Server to be located near the Gateway MSC and connected via a simpler more robust connection. This reduces the signaling demands on the wireless network 12, improves reliability and reduces costs.

The CRBT Server 34 includes storage means for storing a plurality of CRBTs, which can include, but are not limited to snippet of a song, a bit of film dialog, a recorded voice message, or other sound effects. The storage means can be integrated into the CRBT Server 34, or it can be closely coupled to it and located in a data server or another known manner.

The wireless network 12 includes one or more Location Registers, which can include one or more Home Location Registers (HLR), one of which is shown for simplicity at 38. The HLR is a database containing wireless subscriber information for the called party including service subscription information, service restrictions and supplementary services information. This information can be used by the Gateway MSC to determine that the called party is authorized to utilize CRBTs, which should then be sent to the calling party terminal 16. The HLR database also can include information that can be used by the Gateway MSC 30 for routing the call to the called party wireless terminal 18.

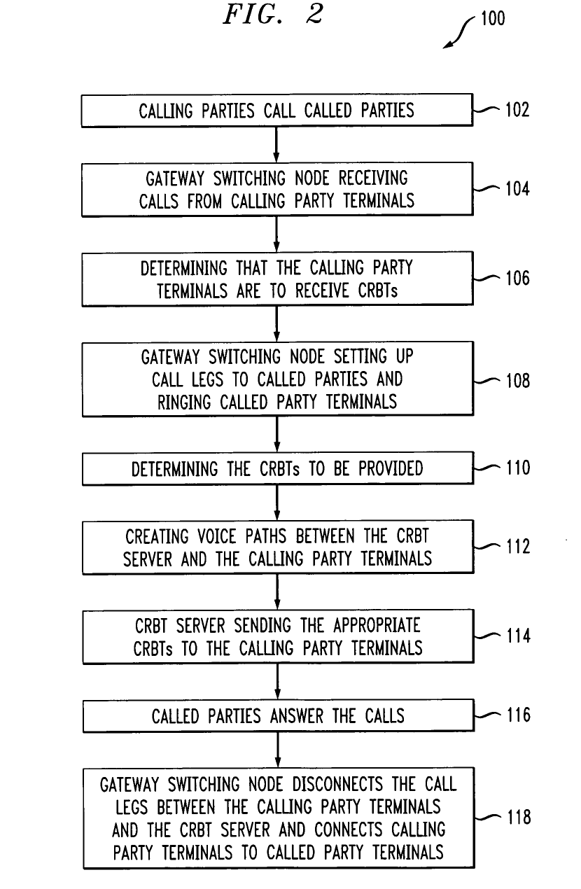

Referring now to FIG. 2, the operation of the system for creating CRBTs shall be described as a method of providing CRBTs as shown generally at 100. The calling parties call the called parties from the PSTN at 102 by dialing the called party phone numbers on the calling party terminals 16. The PSTN 14 routes the calls to the wireless network 12, and the calls are routed to the Gateway MSC 30 which receives them at 104. The Gateway MSC 30 acts as an interface for receiving incoming calls from PSTN directed to a plurality of different wireless terminals served by a plurality of different serving MSCs 26. It should be appreciated that in this example a single Gateway MSC 30 is used for the purposes of simplicity and that more than one Gateway MSC 30 can be used in large wireless networks for routing the calls to the appropriate serving MSCs and called party terminals 18 as well as providing them with CRBTs from one or more CRBT Servers 34 as described herein.

In step 106, it is determined that the calling parties are to receive CRBTs. In one example, which should not be considered limiting, the Gateway MSC 30 consults with the HLR 38, such as via SS7 messaging, or in another known manner, to determine that the incoming calls coming from the calling parties are directed to subscribers having subscription privileges authorizing the use of CRBTs which are to be sent to the calling party terminals 16 in place of traditional ring back tones.

The Gateway MSC 30 sets up call legs having signaling paths to the called party terminals 18 at 108 and the called party terminals are alerted to alert the called parties that they are receiving calls. The Gateway MSC connects the call legs to the appropriate switching nodes 26 in the wireless network (MSC₁-MSCₙ) serving the called party wireless terminals 18, and the appropriate Base Stations (BS₁₁-BS₁ₘ through BSₙ₁-BSₙₘ) to create the call legs between the Gateway MSC 30 and the called party wireless terminals. The serving MSCs, can be the wireless terminal's home MSCs or they can be different MSCs, referred to as visiting MSCs, if the wireless terminals 18 are roaming. The visiting MSCs can be in a wireless network different than wireless network 12. This step can be performed simultaneously with one or more other steps described herein.

After it is determined that the calling parties are to receive CRBTs, the proper CRBTs to be provided are determined at 110. A subscriber to the CRBT service can choose a CRBT upon subscribing, or in any suitable manner, and the desired CRBT can be stored in the CRBT Server 34 and associated with the subscriber, the called party, in a known manner.

The Gateway MSC 30 then creates call legs having voice paths between the CRBT Server 34 and the calling party terminals 16 at 112. The Gateway MSC creates the call legs in a known manner.

The CRBT Server then sends the CRBTs, determined in step 110, to the calling party terminals 16 at 114. The CRBTs are sent from the CRBT Server 30 to the calling party terminals 18 over the call leg voice paths established in step 112. CRBTs can be sent to any phone, including Plain Old Telephones, also known as landlines, via the PSTN because the CRBTs are sent over the call leg voice paths. The CRBT is sent to the calling party terminals 16 while the called party terminals are ringing to let the calling parties know that the called party terminals have been reached and are ringing.

The called parties typically answers their phones at 116 at which time the Gateway MSC at 118 disconnects the calling party call legs to the CRBT Server and connects the call legs to the call legs of the called party terminals thereby creating call legs, having voice paths, connecting the calling party terminals to the called party terminals. Alternatively, if the called parties do not answer, Voice Mail systems may be connected to the call legs thereby connecting the calling party terminals 16 to the Voice Mail systems.

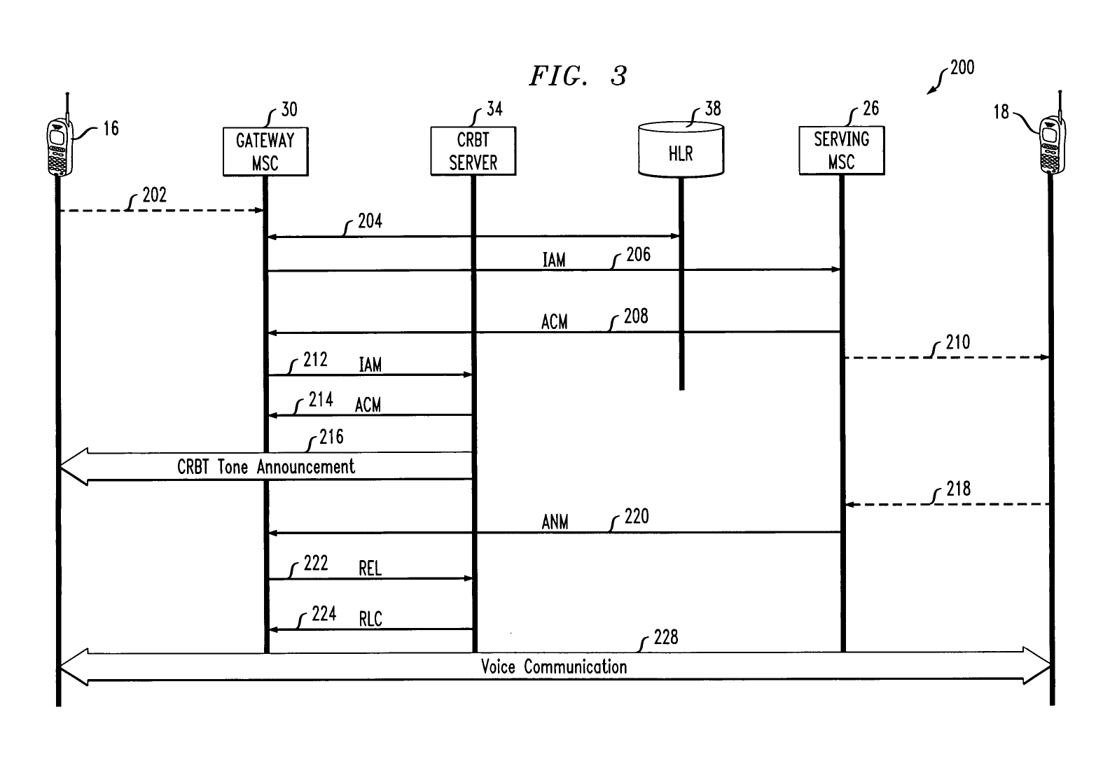

Referring now to FIG. 3, a message flow diagram is shown generally at 200 illustrating one example, which should not be considered limiting, of using ISUP messaging to provide CRBTs using the Gateway MSC 30. A single calling party terminal 16₁ and called party terminal 18₁ are used in this example for simplicity, though it should be appreciated that the Gateway MSC 30 can handle large numbers of such calls simultaneously.

The call from the calling party terminal 16₁ is routed from the PSTN to the Gateway MSC, as shown at 202, which receives the incoming call as described in step 104 above. The Gateway MSC 30 is responsible for routing the call to the serving MSC, MSC₁, serving the called party wireless terminal 18₁, which routes it to the called party terminal via the appropriate Base Station BS₁₁.

The Gateway MSC 30 communicates with the HLR at 204, using a known messaging protocol, such as for example SS7, to determine that the calling party terminal is to receive a CRBT as described above at step 106.

The Gateway MSC 30 rings the called party wireless terminal 18₁ by sending an Initial Address Message (IAM) message to the Serving MSC 26, as shown at 206. The Serving MSC 26 responds to the Gateway MSC 30 with a Address Complete Message (ACM) at 208, and the Serving MSC finds and rings the called party terminal at 210 to alert the called party of an incoming call.

The Gateway MSC 30 also creates a voice path to the CRBT by sending an Initial Address Message (IAM) message to the CRBT Server at 212. The HLR can provide information for selecting the CRBT Server if the wireless network 12 includes more than one. The IAM message passes the Calling Party Number and the called party terminal's Mobile Directory Number (MDN) to the CRBT Server for establishing the voice path.

The CRT Server 34 sends an ACM to the Gateway MSC 30 at 214 so that a voice path can be cut through from the CRBT Server to the calling party terminal as described in step 112 above. The CRBT Server sends the CRBT to the calling party terminal 16₁ via the call leg voice path at 216 while the Serving MSC 26 is ringing the called party terminal 18₁ at 210.

The called party, or a Voice Mail system, answers the call as described in step 116 and shown at 218 and the Serving MSC 26 sends a Answer Message (ANM) to the Gateway MSC as shown at 220. The Gateway MSC 30 then disconnects the calling party's leg to the CRBT sending a Release message (REL) to the CRBT Server as shown at 216. The CRBT Server releases the trunk and its internal resources associated with the call at step 118, described above, and sends a Release Complete (RLC) message to the Gateway MSC 30 at 224. The call leg voice path is established at 228 connecting the calling party terminal 16 to the called party terminal 18 for providing voice communications therebetween.

The Gateway MSC 30 acts as a centralized interface between the PSTN and the MSCs, MSC₁-MSCₙ, serving the wireless terminals 18 and as such, the Gateway MSC can handle many incoming calls from different calling party terminals and provide CRBTs via the CRBT Server to many different calling party terminals at the same time. It should be appreciated that other variants of this messaging scheme can be used to provide CRBTs using a Gateway switching node, such as for example using an Internet Protocol (IP) connection for providing voice communications between the calling party terminal 16 to the called party terminal 18, in which case SIP protocols can be used in place of the ISUP messaging used in the example of FIG. 3.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for providing Custom Ring Back Tones (CRBTs) to calling party terminals calling corresponding called party wireless terminals in a wireless communications network, the wireless communications network communicating with the Public Switched Telephone Network (PSTN) and having a plurality of switching nodes connected to a plurality of base stations for providing over the air communications to the called party wireless terminals, the method comprising:
routing calls from the calling party terminals from the PSTN to a Gateway Switching Node providing a centralized interface between the PSTN and the plurality of switching nodes;
routing the calls from the Gateway Switching Node to the different switching nodes serving the called party wireless terminals;
determining that the calling party terminals are to receive CRBTs;
determining the CRBTs to be provided;
creating voice paths through the Gateway Switching Node between a CRBT Server and the calling party terminals;
sending the CRBTs from the CRBT Server to the calling party terminals via the voice paths; and
creating voice paths between the calling party terminals and the corresponding called party terminals.

2. The method defined in claim 1, wherein the step of determining that the calling party terminals are to receive CRBTs comprises consulting with one or more Location Registers.

3. The method defined in claim 2, wherein the step of consulting with one or more Location Registers includes consulting with a Home Location Register to determine that the called parties are authorized.

4. A system for providing Custom Ring Back Tones (CRBTs) to calling party terminals calling called party wireless terminals in a wireless communications network, the wireless communications network communicating with the Public Switched Telephone Network (PSTN) and having a plurality of switching nodes connected to a plurality of base stations for providing over the air communications to the called party wireless terminals, the system comprising:
a Custom Ring Back Tone (CRBT) server for providing CRBTs; and
a Gateway Switching Node connected to the PSTN and the plurality of wireless communications network switching nodes for providing a centralized interface therebetween, the Gateway Switching Node receiving incoming calls from the PSTN made by calling party terminals to the called party wireless terminals and routing the incoming calls to the wireless communications network switching nodes for connection to the called party wireless terminals, and the Gateway Switching Node connecting the CRBT Server with the calling party terminals for providing the CRBTs thereto.

5. The system defined in claim 4, wherein the CRBT Server is connected to storage means for storing CRBTs provided by the CRBT Server.

6. The system defined in claim 4, wherein the Gateway Switching Node is a Mobile Switching Center.

7. The system defined in claim 4, wherein the plurality of switching nodes are Mobile Switching Centers.

8. An apparatus for providing Custom Ring Back Tones (CRBTs) from one or more CRBT Servers to calling party terminals calling called party wireless terminals in a wireless communications network, the wireless communications network communicating with the Public Switched Telephone Network (PSTN) and having a plurality of switching nodes connected to a plurality of base stations for providing over the air communications to the called party wireless terminals, the apparatus comprising:
a Gateway Switching Node connected to the PSTN and the plurality of wireless communications network switching nodes for providing a centralized interface therebetween, the Gateway Switching Node receiving incoming calls from the PSTN made by calling party terminals to the called party wireless terminals and routing the incoming calls to the wireless communications network switching nodes for connection to the called party wireless terminals, and the Gateway Switching Node connecting the one or more CRBT Servers with the calling party terminals for providing the CRBTs thereto.

9. The apparatus defined in claim 8, wherein the Gateway Switching Node is a Mobile Switching Center.

10. The apparatus defined in claim 8, wherein the plurality of switching nodes are Mobile Switching Centers.
